(19) United States
(12) Patent Application Publication
(10) Pub. No.: US 2019/0251542 A1
(43) Pub. Date: Aug. 15, 2019

(54) METHOD AND SYSTEM FOR INSTANT CREDIT ISSUANCE

(71) Applicant: Mastercard International Incorporated, Purchase, NY (US)

(72) Inventors: Emil Johan Sjoberg, Brooklyn, NY (US); Anna Luscombe, New York, NY (US)

(73) Assignee: Mastercard International Incorporated, Purchase, NY (US)

(21) Appl. No.: 15/897,733

(22) Filed: Feb. 15, 2018

(51) Int. Cl. G06Q 20/24; G06Q 40/02; G06Q 20/40; G06Q 20/22

(52) U.S. Cl. CPC G06Q 20/24; G06Q 20/227; G06Q 20/405; G06Q 40/025

(57) ABSTRACT

A method for issuing instant credit for a transaction includes: receiving an authorization response for a declined payment transaction, wherein the authorization response is formatting according to one or more standards and includes at least a primary account number and a response code indicating a decline; identifying one or more eligibility rules; determining eligibility of a used transaction account associated with the primary account number for instant credit based on at least the identified one or more eligibility rules and data stored in an account profile related to the used transaction account; transmitting at least the determined eligibility of the transaction account to a computing device; receiving an instant credit request; determining a funding transaction account based on at least the data stored in the account profile related to the used transaction account and one or more credit rules; and transmitting at least the determined funding transaction account.

### FIELD

The present disclosure relates to the instant issuing of credit for a payment transaction, specifically the monitoring of account activity for an action that triggers a process for providing an account owner with the opportunity to apply for and receive credit instantly for a transaction, which may be funded by one of a variety of different sources.

### BACKGROUND

Consumers and small businesses are often heavily reliant on credit, particularly in instances where cash flow may be intermittent. Credit enables a small business for instance to be able to purchase items as necessary and pay for the purchases when revenue is actually earned. In such situations, there may come a time where the small business or other entity needs additional credit. When this happens, the small business or other entity can talk to their bank or other financial institution to have a new line of credit open or their current credit limit increased.

However, this is often a very time consuming and involved process. First, the entity must apply for the new line of credit or increase often online or through paper forms such that the information has to be keyed in. Second, the financial institution must perform a credit check that involves accessing potentially multiple databases and services, which on its own can be time consuming as the financial institution must gather information about the entity including from third parties, consult with credit agencies or other third parties, evaluate the entity's credit history, etc. Third, the financial institution makes a decision on whether to extend credit to the entity, and how much should be extended, as well as any other applicable terms. Lastly, the financial institution must affect the extension of credit, either by modifying the limit on an existing account or issuing a new payment instrument to the entity that is associated with a new line of credit. Such a process is computationally intensive, requires multiple communications through potentially varying protocols and application program interfaces, and can often take several days. Even in cases where the process is streamlined, such as by the issuing of a new payment instrument instantly, it may still take hours for the credit check and decision to be performed.

In instances where time may be of the essence for a small business or other entity, a delay of hours to have credit increased or extended may be too long. For example, a small business may have a piece of machinery that needs to be replaced immediately in order to continue operations. The cost may be higher than the available credit to the small business, preventing the small business from making the purchase, which could thereby shut down the small business. Waiting several hours for a decision could be detrimental to the small business, which would in turn create difficulties in the small business repaying their outstanding debts to the financial institution, thus also hurting the financial institution.

More fundamentally, this process is difficult to set up, computationally intensive, requires multiple communications and often human intervention. The technology is a major factor in the delays that are so apparent and problematic, as explained above. As such, there is a need for a technical solution that enables a small business or other entities to apply for and receive credit nearly instantly by creating a new technology and computer architecture that can avoid one or more of the pitfalls of a conventional system, described above.

### SUMMARY

The present disclosure provides a description of systems and methods for the issuing of instant credit for a payment transaction. A system monitors for declined payment transactions that can act as a trigger for an instant crediting process. Once the trigger occurs, the system reaches out to an account owner or their financial institution if the account is eligible to apply for instant credit. If the account owner wishes to continue, a number of rules are instantly applied to the transaction account to determine if the account is eligible for instant credit, as well as how the instant credit will be funded (e.g., through the owner's existing account, through the owner's financial institution, or by a third party lender). The instant credit is then issued to the account owner or an authorized user by a third party system in the form of a virtual payment card, enabling the account owner or user to use the new credit instantly, changing a process that traditionally would take several hours, at best, to one that can be conducted in a manner of seconds.

A method for issuing instant credit for a transaction includes: receiving, by a receiver of a processing server, an authorization response for a declined payment transaction, wherein the authorization response is formatting according to one or more standards and includes at least a primary account number and a response code indicating a decline; identifying, by the processing server, one or more eligibility rules; determining, by the processing server, eligibility of a used transaction account associated with the primary account number for instant credit based on at least the identified one or more eligibility rules and data stored in an account profile related to the used transaction account; electronically transmitting, by a transmitter of the processing server, at least the determined eligibility of the transaction account to a computing device; receiving, by the receiver of the processing server, an instant credit request; determining, by the processing server, a funding transaction account based on at least the data stored in the account profile related to the used transaction account and one or more credit rules; and electronically transmitting, by the transmitter of the processing server, at least the determined funding transaction account.

A system for issuing instant credit for a transaction includes: a receiver of a processing server configured to receive an authorization response for a declined payment transaction, wherein the authorization response is formatting according to one or more standards and includes at least a primary account number and a response code indicating a decline; the processing server configured to identify one or more eligibility rules, and determine eligibility of a used transaction account associated with the primary account number for instant credit based on at least the identified one or more eligibility rules and data stored in an account profile related to the used transaction account; and a transmitter of the processing server configured to electronically transmit at least the determined eligibility of the transaction account to a computing device, wherein

the receiver of the processing server is further configured to receive an instant credit request, the processing server is further configured to determine a funding transaction account based on at least the data stored in the account profile related to the used transaction account and one or more credit rules, and the transmitter of the processing server is further configured to electronically transmit at least the determined funding transaction account.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating high level system architecture for the instant issuing of credit for a transaction in accordance with exemplary embodiments.

FIG. 2 is a block diagram illustrating the processing server of the system of FIG. 1 for triggering the issuing of instant credit for a transaction in accordance with exemplary embodiments.

FIG. 3 is a flow diagram illustrating a process for initiating the instant issuance of credit in the processing server of FIG. 2 in accordance with exemplary embodiments.

FIG. 4 is a flow chart illustrating an exemplary method for issuing instant credit for a transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. Pat. No. 7,359,880, issued Apr. 15, 2008; U.S. Pat. No. 7,895,122, issued Feb. 22, 2011; U.S. Pat. No. 8,229,854, issued Jul. 27, 2012; U.S. Pat. No. 8,321,315, issued Nov. 27, 2012; U.S. Pat. No. 8,510,218, issued Aug. 13, 2013; U.S. Pat. No. 8,639,623, issued Dec. 27, 2012; U.S. Pat. No. 8,756,150, issued Jun. 17, 2014; and U.S. Pat. No. 8,527,416, issued Sep. 3, 2013, each of which are herein incorporated by reference in their entirety.

### System for Instant Issuance of Credit

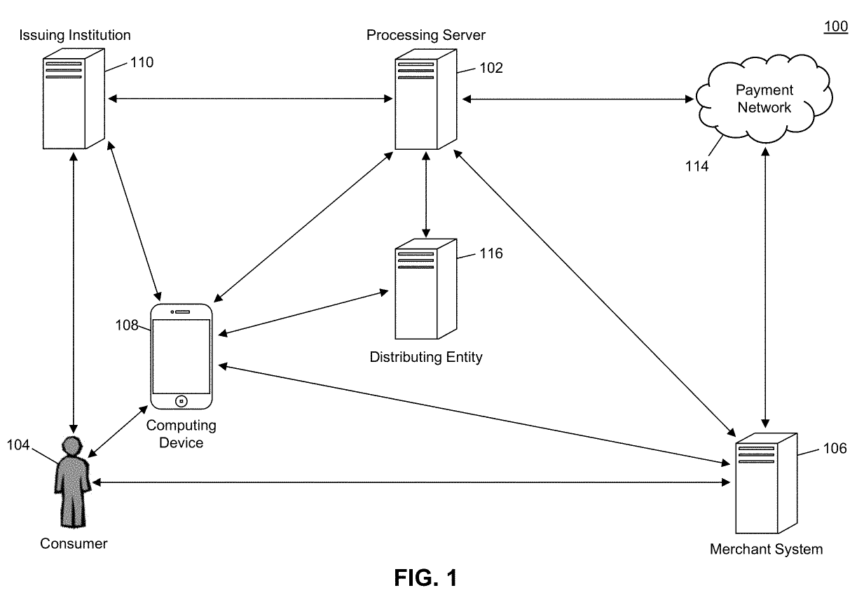

FIG. 1 illustrates a system 100 for the instant issuance of credit for a transaction account for use in a payment transaction following a triggering of the process resulting from a declined payment transaction.

The system 100 may include a processing server 102. The processing server 102, discussed in more detail below, may be configured to monitor the activity of a transaction account to identify when a trigger occurs that initiates a process for the issuing of instant credit to a user associated with the transaction account for use in funding a new payment transaction. In the system 100, a consumer 104 may attempt a payment transaction at a merchant system 106. As discussed herein, the consumer 104 may represent an account owner, authorized user of an account, a small business, or any other entity that may conduct payment transactions and have credit issued thereto or credit issued that may be used thereby. The consumer 104 may have a transaction account issued thereto by an issuing institution 110, which may the consumer 104 may try and use to fund the attempted payment transaction. The issuing institution 110 may be a financial institution, such as an issuing bank, or other type of entity that may be configured to issue transaction accounts to entities for use in funding electronic payment transactions.

The consumer 104 may attempt the payment transaction by providing payment credentials associated with the issued transaction account to the merchant system 106 using any suitable method (e.g., via a physical payment card, electronic submission of payment credentials through an input device or near field communication, etc.). The merchant system 106 may then submit the payment transaction, with the supplied payment credentials, to a payment network 114 for processing. In some cases, the merchant system 106 may submit data for the transaction to an intermediate entity, such as an acquiring institution or gateway processor, which may forward the transaction data to the payment network 114 via payment rails associated therewith.

The payment network 114 may receive a transaction message, generated by the merchant system 106 or another entity on behalf of the merchant system 106 (e.g., an acquiring institution), for the payment transaction. The transaction message may be a specially formatted data message that is formatted according to one or more standards governing the exchange of financial transaction messages, such as the International Organization of Standardization's ISO 8583 or ISO 20022 standards. The transaction message may include a plurality of data elements, where each data element is configured to store transaction data as defined using the applicable standard(s). For instance, the transaction message may include a data element configured to store a primary account number as well as other data elements configured to store other payment credentials, a data element configured to store a transaction amount, a data element configured to store a transaction time and/or date, a data element configured to store a currency type, a data element configured to store an identifier unique to the merchant involved in the payment transaction, etc. Additional data that may be stored in the transaction message may include, for example, geographic location, point of sale identifier, coupon data, offer data, reward data, loyalty data, product data, acquirer data, issuer data, etc. The transaction message may also include a message type indicator, which may indicate a type for the transaction message that may be used in the processing thereof, such indicating the transaction message to be an authorization request or an authorization response. Further, if the issuer offers or has the technical capability to offer alerts regarding nearing spending limits either through the authorization response or through a different channel of communications, such communications can act as a trigger for the offer of instant credit in a given circumstance (e.g., when there is an indication that the card holder will likely need more credit soon, such as during overseas travels or has a history that suggests that this is likely to be so).

The payment network 114 may receive the transaction message for the attempted payment transaction, which may be indicated as being an authorization request, and may process the message accordingly. As part of the processing of the payment transaction, the payment network 114 may forward the authorization request to the issuing institution 110. The issuing institution 110 may determine that the transaction account used to fund the payment transaction has insufficient credit available to cover the transaction amount, and may decline the transaction. Declining of the transaction may include the return of an authorization response (e.g., newly generated or a modification of the authorization request) to the payment network 114 that includes a data element configured to store a response code, where the response code indicates that the payment transaction is declined. In some cases, the response code may further indicate that the payment transaction was declined due to insufficient credit. The payment network 114 may receive the authorization response, which may then be forward to the merchant system 106 (e.g., directly via payment rails of the payment network 114 or through one or more intermediate entities, such as an acquiring institution). The merchant system 106 may inform the consumer 104 of the declined payment transaction using any suitable method.

In the system 100, the processing server 102 may monitor for authorization responses for declined payment transactions to identify instances when a payment transaction is declined, particularly due to insufficient credit. In some embodiments, the payment network 114 or issuing institution 110 may forward authorization responses for declined transactions to the processing server 102. In other embodiments, the processing server 102 may be a part of the issuing institution 110 or payment network 114 and may monitor the network traffic in internal systems to detect when an authorization response is generated, received, or transmitted that includes a response code indicating a declined payment transactions.

A declined payment transaction, particularly if the decline is due to insufficient credit (e.g., if such information is available), may trigger the processing server 102 to start a process for issuing instant credit to the consumer 104. In some cases, additional criteria may have to be fulfilled for the trigger to occur. For instance, the processing server 102 may further check the transaction data in the authorization response for fulfillment of additional criteria to determine if the instant credit issuing process is to be triggered. For example, the trigger may only occur for declined payment transactions with a value above a set amount or that are domestic (e.g., not cross-border transactions).

Once triggered, the processing server 102 may then determine if the transaction account used in the attempted transaction is eligible for consideration for being issued instant credit. The determination may be based on data associated with the transaction account itself and one or more eligibility rules that are applied thereto. The account data may include any data associated with a transaction account and/or an owner or authorized user of the transaction account. For example, such data may include a current credit limit, current balance, repayment history, transaction history, geographic location, biographical information, demographic information, account issuance date, etc. In some cases, eligibility rules may be global for all transaction accounts considered by the processing server 102. In other cases, multiple sets of eligibility rules may be available for the processing server 102, where the processing server 102 may select a set of eligibility rules to use for the transaction account. Such a selection may be based on the issuing institution 110 (e.g., each bank may have its own eligibility rules), geographic location of the declined payment transaction, amount of the declined payment transaction, type of consumer 104 (e.g., different rules for individuals as opposed to businesses), or other criteria.

The processing server 102 may identify the eligibility rules to be used for the consumer 104 and may then apply the eligibility rules to the consumer's transaction account to determine if the consumer 104 is eligible to request instant credit. In some cases, the eligibility rules may also be applied to the transaction data for the attempted payment transaction, as may be parsed from the authorization response. In an example, the eligibility rules may require a minimum income for the consumer 104, the attempted payment transaction being above a predetermined minimum amount, a credit limit within a predefined range, and an account age of at least three years. If the determination is that the consumer 104 is not eligible, then the processing server 102 may perform no further action. In such cases, the consumer 104 would have to forego the payment transaction or attempt another funding source.

If the determination is that the consumer 104 is eligible to request instant credit, then the processing server 102 may transmit such a determination to enable the consumer 104 to request instant credit. In some embodiments, the processing server 102 may provide the determination (e.g., as well as the primary account number or other information identifying the consumer 104 and/or the transaction account, such as may be parsed from the authorization response or identified in local data available to the processing server 102) to the issuing institution 110. The issuing institution 110 may then contact the consumer 104 or provide contact information to the processing server 102 for contacting the consumer 104. In other embodiments, the processing server 102 may contact the consumer 104 directly, such as based on previously provided contact information (e.g., provided by the issuing institution 110 or directly by the consumer 104, such as during a registration process).

A notification may be electronically transmitted to the consumer 104 through a computing device 108 associated therewith. The computing device 108 may be any type of device suitable for performing the functions discussed herein, such as a desktop computer, laptop computer, notebook computer, tablet computer, cellular phone, smart phone, smart watch, smart television, wearable computing device, implantable computing device, etc. The notification may indicate that the consumer 104 is eligible to request instant credit following the declined payment transaction. In some cases, the notification may also include additional data regarding how to apply for the instant credit. In some instances, the notification may also include prospective terms for the instant credit (e.g., a credit limit amount, such as may be based on the attempted payment transaction).

The consumer 104 may then, using their computing device 108, submit a request for instant credit. In some cases, the request may be submitted directly to the processing server 102 using a suitable communication network and method. In other cases, the request may be submitted to the issuing institution 110, which may then forward the request to the processing server 102. The request may include at least the identifying information associated with the consumer 104 and/or transaction account. In some embodiments, the request may also include desired terms or other information for the requested instant credit, such as a credit amount, interest rate, repayment schedule, etc.

The processing server 102 may then determine if instant credit should be issued to the consumer 104, any applicable terms, as well as how the instant credit should be funded. The processing server 102 may apply one or more credit rules to the data associated with the transaction account to determine if the consumer 104 is approved for instant credit. The credit rules may be associated with the issuing institution 110, such that each institution may have its own rules predetermined to control what transaction accounts may have instant credit issued thereto. In some cases, credit rules may also be selected based on desired terms or other data provided by the consumer 104. In some embodiments, an issuing institution 110 may be associated with multiple sets of credit rules, where each may determine approval for instant credit for the transaction account with respect to specific terms. For example, one set of credit rules may, if the consumer 104 is approved, provide the consumer 104 with instant credit at one(e.g., 5%) interest rate, while a second set of credit rules may, if the consumer 104 is approved, provide the consumer 104 with instant credit at a higher (e.g., 10%) interest rate. In such cases, the credit rules may have a priority associated therewith, such that the highest priority credit rules that result in an approval will be used in the issuing of instant credit to the consumer 104 (e.g., offering the most favorable terms that the consumer 104 is eligible for). In some instances, the credit rules may also determine if the instant credit is to be funded by the transaction account (e.g., representing an increase in the credit limit for the transaction account) or by a separate account, such as one held by the issuing institution 110 for use in funding instant credit extensions, which may be necessary if the issuing institution 110 cannot instantly increase the available credit on the consumer's transaction account. In instances where both options may be available to the consumer 104, the consumer 104 may be provided with a chance to select which account will be used to fund the instant credit (e.g., where terms may differ between the transaction accounts).

In some embodiments, the system 100 may include one or more lenders as an alternative to the issuing institution 110. For instance, the issuing institution 110 may be unwilling to approve the consumer 104 for instant credit, or a lender may be willing to issue the consumer 104 instant credit with more favorable terms than the consumer's issuing institution 110. In such cases, the processing server 102 may use credit rules associated with a lender to determine approval of the consumer 104. In some such cases, a lender may have multiple sets of credit rules associated therewith, such as discussed above, to determine terms of approval of the consumer 104. In these embodiments, instant credit issued to the consumer 104 will be on a transaction account issued to or otherwise associated with the lender. In some cases, the consumer 104 may be required to give consent (e.g., prior to submission of the request, in the request, or once approval of the consumer 104 for the credit has been obtained) to be issued instant credit by an outside lender.

Once the consumer 104 has been approved (e.g., and accepted, if necessary), instant credit may be issued to the consumer 104 that are subject to applicable terms, which may have been decided based on the consumer's submitted request and/or the credit rules that resulted in the approval. The processing server 102 may electronically transmit at least the approval information to a distributing entity 116. The approval information may include at least information identifying the funding transaction account, and any terms needed in the issuing of a payment instrument to the consumer 104. The distributing entity 116, which may be the issuing institution 110 or a third party, may be configured to instantly issue a payment instrument to the consumer 104 that may be used to access the instant credit being issued thereto. The payment instrument may be a temporary payment card, virtual payment card (e.g., transmitted to the computing device 108), payment credentials electronically or otherwise transmitted to the consumer 104, or any other type of payment instrument that may be instantly issued and used by the consumer 104 in funding a payment transaction. The consumer 104 may receive the payment instrument, which may then be presented to the merchant system 106. The merchant system 106 may then process a new payment transaction, which may be successfully funded via the new, instant credit.

As discussed above, the process executed in the system 100 for the issuing of instant credit to the consumer 104 may be conducted instantly, which may be limited only by the speed at which communications may be exchanged and processing performed. For example, because the eligibility rules and credit rules are available prior to the determinations being performed, and because the issuing institution 110 and/or lenders do not need to be contacted during the processing, the processing server 102 may perform all of its functions instantly, with credit being issued as quickly as the consumer 104 can submit the request and the distributing entity 116 can have the new payment instrument distributed to the consumer 104. The result is a method and system where a consumer 104 can quickly and efficiently receive new credit that can be used in a payment transaction following a declined payment transaction that triggers the process. The use of multiple funding sources may ensure that the credit can be available to the consumer 104 instantly, and that any subsequent transactions may be covered to prevent any further declines, provided that any new transactions comply with terms of the instant credit. Thus, the method and system discussed herein can provide for the instant issuance of credit to a consumer 104, improving a process that traditionally could take several hours, if not days, to one that can be executed in a manner of seconds.

### Processing Server

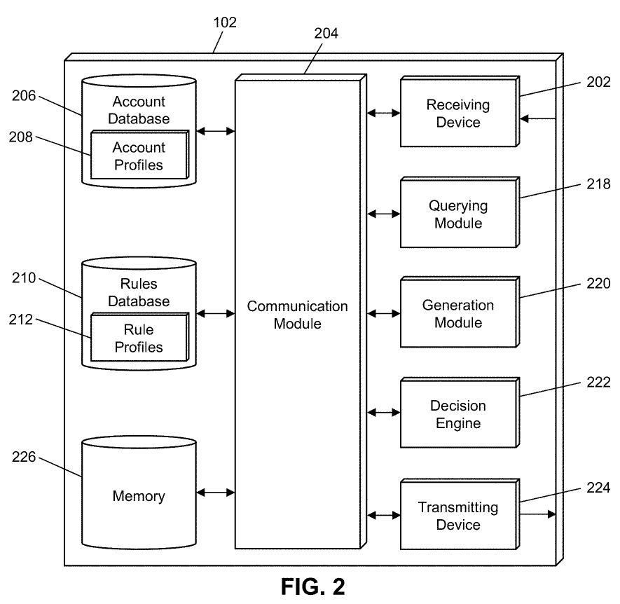

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from merchant systems 106, payment networks 114, issuing institutions 110, computing devices 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchant systems 106, issuing institutions 110, or payment networks 114 that may be superimposed or otherwise encoded with transaction messages, including authorization responses for declined payment transactions. The receiving device 202 may also be configured to receive data signals electronically transmitted by computing devices 108 and issuing institutions 110, which may be superimposed or otherwise encoded with instant credit requests, acceptances/declines of instant credit, or other data as discussed herein.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, decision engine 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. A account profile 208 may include at least data associated with the transaction account that may be used in determining eligibility for instant credit requests and approval for instant credit based on application of eligibility rules and credit rules thereto, respectively. Such data may include, for instance, credit limits, balances, credit terms, transaction history, repayment history, demographic information, biographic information, etc. In some cases, an account profile 208 may also include data regarding instant credit that has been issued based on the related transaction account, such as the funding sources for such credit.

The processing server 102 may also include a rules database 210. The rules database 210 may be configured to store a plurality of rule profiles 212 using a suitable data storage format and schema. The rules database 210 may be a relational database that utilizes structured query language for the storage, identification, modifying, updating, accessing, etc. of structured data sets stored therein. Each rule profile 212 may be a structured data set configured to store data related to credit rules or eligibility rules. Each rule profile 212 may store the respective rules as well as criteria used in the selection and applicability of the respective rules. For instance, a rule profile 212 may store information associated with an issuing institution 110, where the rules are to apply to transaction accounts issued by that institution. In another example, a rule profile 212 may include terms for instant credit approved via the rules, account details for a transaction account to fund instant credit approved via the rules, etc.

The processing server 102 may include a querying module 218. The querying module 218 may be configured to execute queries on databases to identify information. The querying module 218 may receive one or more data values or query strings, and may execute a query string based thereon on an indicated database, such as the account database 206, to identify information stored therein. The querying module 218 may then output the identified information to an appropriate engine or module of the processing server 102 as necessary. The querying module 218 may, for example, execute a query on the account database 206 to identify an account profile 208 related to a transaction account used in a declined payment transaction. The querying module 218 may also execute a query on the rules database 210 to identify a rule profile 212 that includes eligibility rules associated with the issuing institution 110 that issued the transaction account for determining eligibility of the consumer 104 for requesting instant credit.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to issuing institutions 110 and computing devices 108, such as notifications regarding eligibility for instant credit, approval terms for instant credit, etc.

The processing server 102 may also include a decision engine 222. The decision engine 222 may be configured to make decisions for the processing server 102 as part of the functions discussed herein. The decision engine 222 may receive data and instructions as input, may make a decision using the available data, and may output a result of the decision to another module or engine of the processing server 102. The decision engine 222 may, for example, be configured to determine if a transaction account is eligible to request instant credit issuance based on the application of eligibility rules to account information. The decision engine 222 may also be configured to determine if a transaction account is approved for instant credit based on the application of credit rules to account information. In some cases, the decision engine 222 may also be configured to determine terms or restrictions for instant credit, as well as determine the funding account that will back instant credit being issued to a consumer 104.

The processing server 102 may also include a transmitting device 224. The transmitting device 224 may be configured to transmit data over one or more networks via one or more network protocols. In some instances, the transmitting device 224 may be configured to transmit data to computing devices 108, issuing institutions 110, distributing entities 116, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to computing devices 108 and issuing institutions 110 that may be superimposed or otherwise encoded with notifications, including notifications regarding eligibility for requesting instant credit, notifications regarding approval of instant credit, notifications regarding terms of accepted instant credit, etc. The transmitting device 224 may also be configured to electronically transmit data signals to distributing entities 116, which may be superimposed or otherwise encoded with instructions to issue a payment instrument to the consumer 104 for instant credit, which may include funding transaction account information, contact information for the consumer 104, and any other data suitable for use by the distributing entity 116.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, instant credit terms, lender information, transaction processing rules, merchant data, etc.

### Process for Determining Eligibility for Instant Credit

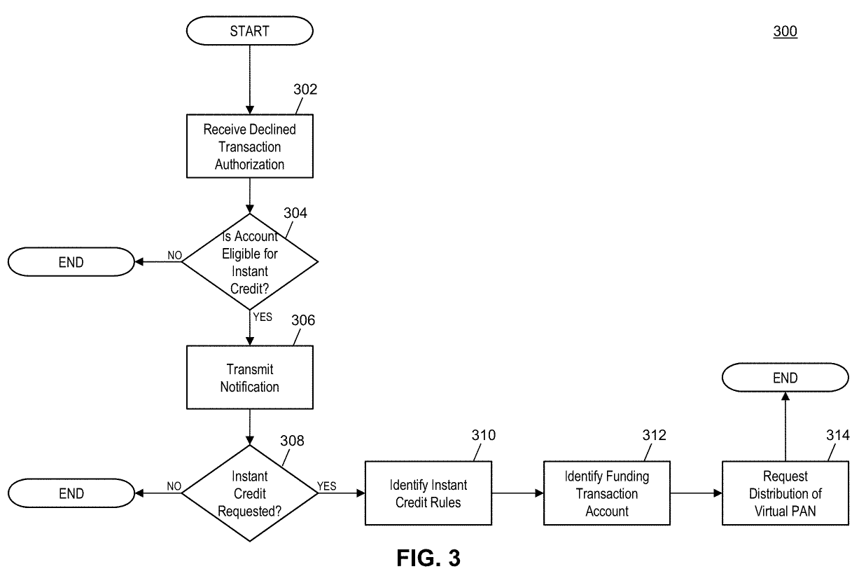

FIG. 3 illustrates an example process 300 for determining if a consumer 104 is eligible to request for, and receive, instant credit in the system 100 as executed by the processing server 102.

In step 302, the receiving device 202 of the processing server 102 may receive an authorization response for a declined payment transaction. The authorization response may include at least a data element configured to store a primary account number associated with a transaction account, referred to herein as the “used transaction account” that was used in the attempted payment transaction. In some embodiments, the authorization response may include a data element configured to store a response code indicative of a decline. In a further embodiment, the response code may indicate that the payment transaction was declined for insufficient credit.

In step 304, the processing server 102 may determine if the used transaction account is eligible to request the issuance of instant credit. The querying module 218 of the processing server 102 may execute a query on the account database 206 to identify an account profile 208 related to the used transaction account based on the primary account number, as well as a query on the rules database 210 to identify a rule profile 212 that includes applicable eligibility rules, which may be based on the issuing institution 110 (e.g., identified by the primary account number, such as using a bank identification number included therein). The decision engine 222 of the processing server 102 may then apply the eligibility rules to the account information in the identified account profile 208 to determine if the transaction account is eligible to request the issuance of instant credit. If the determination is that the transaction account is not eligible, then the process 300 may be completed.

If the determination is that the transaction account is eligible, then, in step 306, the transmitting device 224 of the processing server 102 may electronically transmit a notification to the consumer 104 (e.g., indirectly via the issuing institution 110 or directly via the computing device 108 associated therewith) notifying the consumer 104 that they are eligible to request instant credit. In step 308, the processing server 102 may determine if instant credit was requested by the consumer 104. The determination may be based on if a request was received by the receiving device 202 thereof. In some cases, the consumer 104 may be provided with a predetermined period of time to submit a request after the notification was transmitted by the processing server 102. In such cases, in step 308, the processing server 102 will wait the predetermined period of time before making the determination. If no request was submitted, then the process 300 may be completed.

If a request was submitted, then, in step 310, the querying module 218 may execute a query on the rules database 210 to identify one or more rule profiles 212 that include credit rules that are applicable to the used transaction account, such as may be determined based on the issuing institution 110, account information for the used transaction account, transaction data parsed from the authorization response, etc. In step 312, the decision engine 222 of the processing server 102 may apply each identified set of credit rules to the account information and any other data to determine if the used transaction account is approved for instant credit under the respective rules. The decision engine 222 may also select a funding transaction account based on which sets of credit rules the used transaction account was approved under, such as by selecting the one most favorable to the consumer 104, selecting one based on predefined consumer criteria, or other selection criteria. In some embodiments, the issuing institution 110 or lender associated with the selected funding transaction may be contacted to approve the issuing of instant credit in accordance with the applied credit rules. In some instances, the consumer 104 may also be contacted for approval, such as of terms associated with the applied credit rules. In step 314, the transmitting device 224 of the processing server 102 may electronically transmit a request to the distributing entity 116 requesting that a virtual payment account number be issued to the consumer 104 that is associated with the selected funding transaction account for use of the instant credit as determined by the decision engine 222.

### Exemplary Method for Issuing Instant Credit for a Transaction

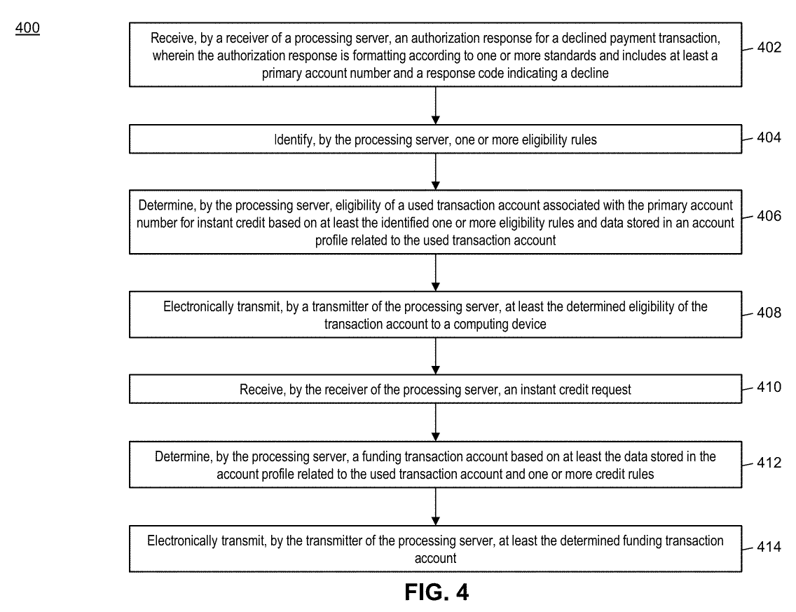

FIG. 4 illustrates a method 400 for the issuing of instant credit for a transaction following a trigger due to a payment transaction decline for insufficient credit and a determination of eligibility.

In step 402, an authorization response for a declined payment transaction may be received by a receiver (e.g., the receiving device 202) of a processing server (e.g., the processing server 102), wherein the authorization response is formatting according to one or more standards and includes at least a primary account number and a response code indicating a decline. In step 404, one or more eligibility rules may be identified by the processing server.

In step 406, eligibility of a used transaction account associated with the primary account number for instant credit may be determined by the processing server based on at least the identified one or more eligibility rules and data stored in an account profile related to the used transaction account. In step 408, at least the determined eligibility of the transaction account may be electronically transmitted by a transmitter (e.g., the transmitting device 224) of the processing server to a computing device (e.g., the computing device 108 or issuing institution 110).

In step 410, an instant credit request may be received by the receiving of the processing server. In step 412, a funding transaction account may be determined by the processing server based on at least the data stored in the account profile related to the used transaction account and one or more credit rules. In step 414, at least the determined funding transaction account may be electronically transmitted by the transmitter of the processing server.

In one embodiment, the determined funding transaction account may be electronically transmitted to the computing device. In some embodiments, the method 400 may further include: receiving, by the receiver of the processing server, a mobile device identifier from the computing device; and electronically transmitting, by the transmitter of the processing server, at least the determined eligibility of the transaction account to a mobile device (e.g., the computing device 108) associated with the mobile device identifier, wherein the instant credit request is received from the mobile device. In one embodiment, the instant credit request may be received from the computing device.

In some embodiments, the determined funding transaction account may be electronically transmitted to a third party system (e.g., the distributing entity 116). In one embodiment, the response code may indicate the decline being due to insufficient credit for the used transaction account. In some embodiments, the used transaction account and the funding transaction account may be the same transaction account. In one embodiment, the method 400 may also include storing, in a memory (e.g., the memory 226, rules database 210, etc.) of the processing server, a plurality of sets of eligibility rules, wherein each set of eligibility rules is associated with an issuing institution, and the one or more eligibility rules are included in one of the plurality of sets of eligibility rules where the associated issuing institution corresponds to the primary account number.

In some embodiments, the method 400 may further include storing, in a memory of the processing server, a plurality of potential transaction accounts, wherein the one or more credit rules includes at least a set of credit rules associated with each of the plurality of potential transaction accounts, and determination of the funding transaction account is further based on results of application of each of the sets of credit rules to the data stored in the account profile related to the used transaction account. In a further embodiment, the used transaction account may be one of the plurality of potential transaction accounts.

### Computer System Architecture

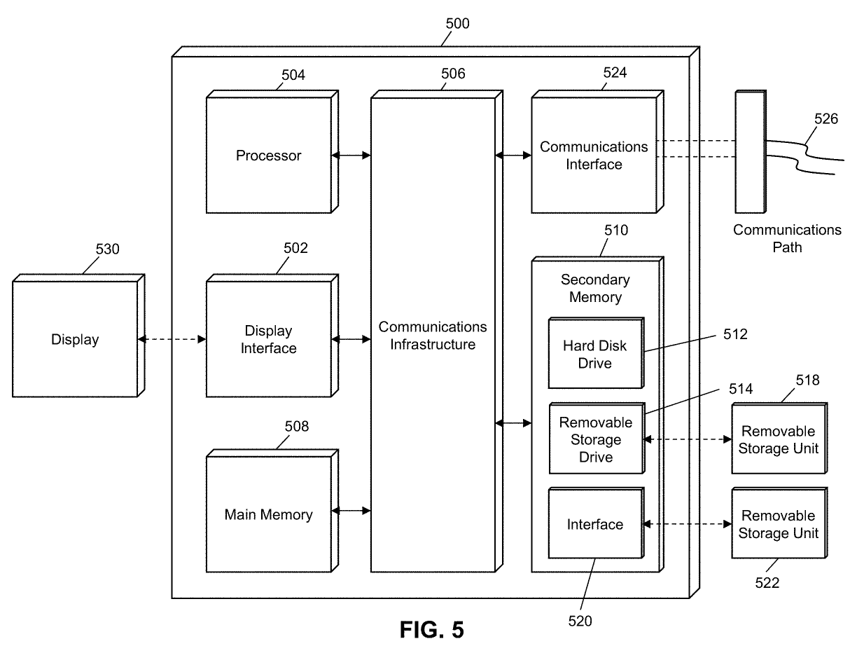

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for issuing instant credit for a transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for issuing instant credit for a transaction, comprising:
receiving, by a receiver of a processing server, an authorization response for a declined payment transaction, wherein the authorization response is formatting according to one or more standards and includes at least a primary account number and a response code indicating a decline;
identifying, by the processing server, one or more eligibility rules;
determining, by the processing server, eligibility of a used transaction account associated with the primary account number for instant credit based on at least the identified one or more eligibility rules and data stored in an account profile related to the used transaction account;
electronically transmitting, by a transmitter of the processing server, at least the determined eligibility of the transaction account to a computing device;
receiving, by the receiver of the processing server, an instant credit request;
determining, by the processing server, a funding transaction account based on at least the data stored in the account profile related to the used transaction account and one or more credit rules; and
electronically transmitting, by the transmitter of the processing server, at least the determined funding transaction account.

2. The method of claim 1, wherein the determined funding transaction account is electronically transmitted to the computing device.

3. The method of claim 1, further comprising:
receiving, by the receiver of the processing server, a mobile device identifier from the computing device; and
electronically transmitting, by the transmitter of the processing server, at least the determined eligibility of the transaction account to a mobile device associated with the mobile device identifier, wherein
the instant credit request is received from the mobile device.

4. The method of claim 1, wherein the instant credit request is received from the computing device.

5. The method of claim 1, wherein the determined funding transaction account is electronically transmitted to a third party system.

6. The method of claim 1, wherein the response code indicates the decline being due to insufficient credit for the used transaction account.

7. The method of claim 1, wherein the used transaction account and the funding transaction account are the same transaction account.

8. The method of claim 1, further comprising:
storing, in a memory of the processing server, a plurality of sets of eligibility rules, wherein
each set of eligibility rules is associated with an issuing institution, and
the one or more eligibility rules are included in one of the plurality of sets of eligibility rules where the associated issuing institution corresponds to the primary account number.

9. The method of claim 1, further comprising:
storing, in a memory of the processing server, a plurality of potential transaction accounts, wherein
the one or more credit rules includes at least a set of credit rules associated with each of the plurality of potential transaction accounts, and
determination of the funding transaction account is further based on results of application of each of the sets of credit rules to the data stored in the account profile related to the used transaction account.

10. The method of claim 9, wherein the used transaction account is one of the plurality of potential transaction accounts.

11. A system for issuing instant credit for a transaction, comprising:
a receiver of a processing server configured to receive an authorization response for a declined payment transaction, wherein the authorization response is formatting according to one or more standards and includes at least a primary account number and a response code indicating a decline;
the processing server configured to
identify one or more eligibility rules, and
determine eligibility of a used transaction account associated with the primary account number for instant credit based on at least the identified one or more eligibility rules and data stored in an account profile related to the used transaction account; and
a transmitter of the processing server configured to electronically transmit at least the determined eligibility of the transaction account to a computing device, wherein
the receiver of the processing server is further configured to receive an instant credit request,
the processing server is further configured to determine a funding transaction account based on at least the data stored in the account profile related to the used transaction account and one or more credit rules, and
the transmitter of the processing server is further configured to electronically transmit at least the determined funding transaction account.

12. The system of claim 11, wherein the determined funding transaction account is electronically transmitted to the computing device.

13. The system of claim 11, wherein
the receiver of the processing server is further configured to receive a mobile device identifier from the computing device,
the transmitter of the processing server is further configured to electronically transmit at least the determined eligibility of the transaction account to a mobile device associated with the mobile device identifier, and
the instant credit request is received from the mobile device.

14. The system of claim 11, wherein the instant credit request is received from the computing device.

15. The system of claim 11, wherein the determined funding transaction account is electronically transmitted to a third party system.

16. The system of claim 11, wherein the response code indicates the decline being due to insufficient credit for the used transaction account.

17. The system of claim 11, wherein the used transaction account and the funding transaction account are the same transaction account.

18. The system of claim 11, further comprising:
a memory of the processing server configured to store a plurality of sets of eligibility rules, wherein
each set of eligibility rules is associated with an issuing institution, and
the one or more eligibility rules are included in one of the plurality of sets of eligibility rules where the associated issuing institution corresponds to the primary account number.

19. The system of claim 11, further comprising:
a memory of the processing server configured to store a plurality of potential transaction accounts, wherein
the one or more credit rules includes at least a set of credit rules associated with each of the plurality of potential transaction accounts, and
determination of the funding transaction account is further based on results of application of each of the sets of credit rules to the data stored in the account profile related to the used transaction account.

20. The system of claim 19, wherein the used transaction account is one of the plurality of potential transaction accounts.
